(19) United States
(12) Patent Application Publication
(10) Pub. No.: US 2026/0132039 A1
(43) Pub. Date: May 14, 2026

(54) METHOD FOR EXTRACTING POTASSIUM BICARBONATE FROM MINERAL MIXTURES

(71) Applicant: Kellium Minerals LLC, Utica, IL (US)

(72) Inventor: Nicholas W. Kelsey, Utica, IL (US)

(21) Appl. No.: 19/384,962

(22) Filed: Nov. 10, 2025

Related U.S. Application Data
(60) Provisional application No. 63/718,195, filed on Nov. 8, 2024.

(51) Int. Cl. C01D 7/06

(52) U.S. Cl. CPC C01D 7/06

(57) ABSTRACT

The present disclosure provides a method for extracting potassium bicarbonate from a mineral mixture. The method includes combining potassium chloride, sodium bicarbonate, and magnesium carbonate trihydrate in an aqueous solution. The aqueous solution is cooled to form Engel's salt comprising potassium bicarbonate magnesium carbonate tetrahydrate. Engel's salt is separated from the aqueous solution and leached with water to produce an aqueous potassium bicarbonate solution and magnesium carbonate trihydrate. The method may further include recycling at least a portion of the magnesium carbonate trihydrate produced from leaching Engel's salt back into the aqueous solution. The aqueous potassium bicarbonate solution can be processed to produce various potassium bicarbonate products.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD

The present disclosure relates to methods and systems for producing inorganic compounds, and more particularly to a method of extracting potassium bicarbonate from mineral mixtures containing potassium chloride and sodium bicarbonate.

### INTRODUCTION

Potassium bicarbonate is a valuable compound with numerous applications in agriculture, food production, and industrial processes. It is commonly used as a fertilizer, food additive, and pH regulator. Traditional methods for producing potassium bicarbonate often involve energy-intensive processes or rely on synthetic precursors.

Natural mineral deposits containing potassium and bicarbonate ions exist, but direct extraction of potassium bicarbonate from these sources has proven challenging. Potash deposits, which primarily consist of potassium chloride, are abundant and widely mined. However, converting potassium chloride to potassium bicarbonate typically requires multiple chemical conversion steps.

Existing processes for potassium bicarbonate production frequently utilize potassium hydroxide or potassium carbonate as intermediates. These methods may involve high temperatures, pressurized conditions, electrochemistry, or the use of additional reagents. Such approaches can be costly and may result in unwanted byproducts or impurities in the final product.

For example, U.S. Pat. No. 5,415,877 titled “Bicarbonate fungicide product with a combination of surfactant ingredients” describes a dry blend fungicide composition containing a bicarbonate salt (like sodium or potassium bicarbonate), a hydrophilic polymer, and a combination of surfactants. The surfactants act as spreader-stickers when the composition is diluted with water and applied to plants. The formulation is free-flowing, non-caking, and effective against fungal diseases on plants.

WO Pub. No. 1994018831 titled “Bicarbonate fungicide compositions containing spreader-sticker and film-forming ingredients” discloses aqueous and dry blend fungicide compositions containing at least two bicarbonate salts, a fatty acid salt, and a hydrophilic polymer. These ingredients function as spreader-stickers and film-formers when applied to plant foliage. The compositions can also include fertilizer elements. They are effective against fungi and adhere well to plants.

U.S. Pat. No. 2,045,203 titled “Decomposition of engel salt” describes a method for decomposing Engel's salt (potassium magnesium carbonate) to produce potassium carbonate and magnesium carbonate trihydrate. The process involves treating Engel's salt with water at elevated temperatures in multiple stages, with temperatures decreasing in each subsequent stage. This method reduces the formation of undesirable basic magnesium compounds.

U.S. Pat. No. 2,905,529 titled “Preparation of engel's salt” outlines a process for producing Engel's salt by reacting potassium bicarbonate with magnesium carbonate in an aqueous suspension. The reaction is carried out at temperatures between 20-50° C. The resulting Engel's salt precipitate is easily filtered and washed.

U.S. Pat. No. 2,752,222 titled “Preparation of potassium bicarbonate” describes a method for producing potassium bicarbonate by reacting potassium chloride with carbon dioxide and water in the presence of certain amines (like methylamine or ethylamine). The amine helps facilitate the reaction and results in easily separable potassium bicarbonate crystals.

U.S. Pat. No. 1,967,630 titled “Making potassium bicarbonate and magnesium carbonate trihydrate from engel salt” details a process for decomposing Engel's salt to produce potassium bicarbonate and magnesium carbonate trihydrate. The method involves treating Engel's salt with water in multiple stages at decreasing temperatures above atmospheric pressure. The presence of magnesium bicarbonate helps suppress the formation of basic magnesium compounds.

U.S. Pat. No. 2,020,801 titled “Cyclic manufacture of potassium carbonate” outlines a cyclic process for producing potassium carbonate from potassium chloride. The process involves forming Engel's salt, decomposing it to potassium bicarbonate and magnesium carbonate, then converting the bicarbonate to carbonate. The magnesium carbonate is recycled back into the process.

U.S. Pat. No. 4,919,910 titled “Process for the production of potassium bicarbonate” describes a method for producing potassium bicarbonate by reacting potassium carbonate with carbon dioxide in an aqueous solution. The process involves carefully controlling temperature, pressure, and CO₂ flow to optimize crystal formation and purity. The resulting potassium bicarbonate crystals have high purity and desirable physical properties.

While the disclosures above provide for the creation of various intermediates and products, there is growing interest in developing more efficient and environmentally friendly methods for producing potassium bicarbonate, particularly from naturally occurring mineral sources. Ideally, such methods would minimize energy consumption, reduce or eliminate the use of synthetic precursors, and yield a high-purity product suitable for various applications.

Additional examples include U.S. Pat. No. 3,141,730 titled “Production of potassium bicarbonate” that describes a process for producing potassium bicarbonate by treating an aqueous solution of potassium carbonate with carbon dioxide in the presence of an amine. The amine helps produce a free-flowing potassium bicarbonate product that maintains its free-flowing characteristics over time. The process involves carbonating a potassium carbonate solution with CO₂ gas in the presence of a polar amine with 4-20 carbon atoms. The resulting potassium bicarbonate crystals are filtered, washed, and dried to produce the final product.

U.S. Pat. No. 5,449,506 titled “Process for producing potassium carbonate” outlines a continuous process for producing potassium carbonate using a countercurrent cation exchange system. Potassium chloride and ammonium carbonate solutions are fed into the ion exchange system, resulting in potassium carbonate solution and ammonium chloride byproduct. The potassium carbonate solution is steam stripped to remove residual ammonium carbonate, then evaporated and dried to form anhydrous granulated potassium carbonate. The ammonium chloride byproduct is treated with lime to recover ammonia, which is recycled back into the process.

U.S. Pat. No. 3,773,902 titled “Process for the preparation of potassium carbonate hydrate” describes a continuous process for producing potassium carbonate hydrate by reacting aqueous potassium hydroxide solution with carbon dioxide gas. The reaction occurs at 80-135° C. and 130 mmHg to atmospheric pressure. Water evaporates during the reaction to precipitate potassium carbonate hydrate crystals. The slurry is removed, the crystals are separated, and the mother liquor is recycled back to the reaction zone. This single-stage process utilizes the heat of neutralization for water evaporation and crystallization.

U.S. Pat. No. 3,975,503 titled “Method for producing alkali carbonate” details a method for producing alkali carbonate crystals (sodium or potassium) by adding alkali hydroxide solution to a circulating alkali carbonate/hydroxide solution, spraying the mixture into hot CO₂-containing gas (150-700° C.), collecting the remaining liquid after 0.1-10 seconds, separating the carbonate crystals, and recycling the liquid. For sodium carbonate, it produces monohydrate crystals. For potassium carbonate, it can produce either hydrated or anhydrous crystals depending on conditions. The process utilizes hot exhaust gases and requires minimal equipment.

What is needed, however, are new methods of producing potassium bicarbonate. Extracting potassium bicarbonate directly from mineral mixtures presents several challenges, including selective separation of potassium from other ions, efficient conversion of chloride to bicarbonate, and removal of impurities. Overcoming these obstacles could lead to more sustainable and economical production of this important compound.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for extracting potassium bicarbonate from a mineral mixture is provided. The method includes combining potassium chloride, sodium bicarbonate, and magnesium carbonate trihydrate in an aqueous solution. The method further includes cooling the aqueous solution to form Engel's salt comprising potassium bicarbonate magnesium carbonate tetrahydrate. The method also includes separating Engel's salt from the aqueous solution. Additionally, the method includes leaching Engel's salt with water to produce an aqueous potassium bicarbonate solution and magnesium carbonate trihydrate.

According to other aspects of the present disclosure, the method may include one or more of the following features. Cooling the aqueous solution may comprise cooling to a temperature between 0° C. and 20° C. The method may further comprise adding magnesium chloride to the aqueous solution. Leaching Engel's salt may comprise heating to a temperature between 40° C. and 70° C. The method may further comprise recycling at least a portion of the magnesium carbonate trihydrate produced from leaching Engel's salt back into the aqueous solution. The method may further comprise purging 0-100% of the recycled magnesium carbonate trihydrate. The method may further comprise processing the aqueous potassium bicarbonate solution to produce a potassium bicarbonate product selected from the group consisting of: an aqueous solution, a crystallized solid, and a spray-dried powder.

According to another aspect of the present disclosure, a system for extracting potassium bicarbonate from a mineral mixture is provided. The system includes a crystallization unit configured to combine potassium chloride, sodium bicarbonate, and magnesium carbonate trihydrate in an aqueous solution and cool the aqueous solution to form Engel's salt comprising potassium bicarbonate magnesium carbonate tetrahydrate. The system also includes a separation unit configured to separate Engel's salt from the aqueous solution. Additionally, the system includes a leaching unit configured to leach Engel's salt with water to produce an aqueous potassium bicarbonate solution and magnesium carbonate trihydrate.

According to other aspects of the present disclosure, the system may include one or more of the following features. The crystallization unit may be configured to cool the aqueous solution to a temperature between 0° C. and 20° C. The system may further comprise a magnesium chloride addition unit configured to add magnesium chloride to the aqueous solution in the crystallization unit. The leaching unit may be configured to heat Engel's salt and water to a temperature between 40° C. and 70° C. The system may further comprise a recycling unit configured to recycle at least a portion of the magnesium carbonate trihydrate produced from leaching Engel's salt back into the crystallization unit. The system may further comprise a purge unit configured to purge 0-20% of the recycled magnesium carbonate trihydrate. The system may further comprise a processing unit configured to process the aqueous potassium bicarbonate solution to produce a potassium bicarbonate product. The processing unit may be configured to produce a potassium bicarbonate product selected from the group consisting of: an aqueous solution, a crystallized solid, and a spray-dried powder.

According to another aspect of the present disclosure, a method for producing potassium bicarbonate is provided. The method includes forming Engel's salt comprising potassium bicarbonate magnesium carbonate tetrahydrate from a mixture of potassium chloride, sodium bicarbonate, and magnesium carbonate trihydrate. The method also includes separating Engel's salt from the mixture. Additionally, the method includes decomposing Engel's salt to yield an aqueous potassium bicarbonate solution.

According to other aspects of the present disclosure, the method may include one or more of the following features. Forming Engel's salt may comprise cooling an aqueous solution containing the potassium chloride, sodium bicarbonate, and magnesium carbonate trihydrate to a temperature between 0° C. and 20° C. The method may further comprise adding magnesium chloride to the aqueous solution prior to cooling. Decomposing Engel's salt may comprise heating Engel's salt with water to a temperature between 40° C. and 70° C. The method may further comprise recycling at least a portion of magnesium carbonate trihydrate produced from decomposing Engel's salt back into the mixture for forming additional Engel's salt.

The foregoing general description of the illustrative embodiments and the following detailed description thereof are merely exemplary aspects of the teachings of this disclosure and are not restrictive.

### DRAWINGS

Those of skill in the art will understand that the drawings, described below, are for illustrative purposes only. The drawings are not intended to limit the scope of the present teachings in any way.

FIG. 1 illustrates a system diagram for producing potassium bicarbonate and carbonate products, according to aspects of the present disclosure.

### DETAILED DESCRIPTION

### Abbreviations and Definitions

To facilitate understanding of the invention, a number of terms and abbreviations as used herein are defined below as follows:
Double salt: As used herein, the term “double salt” refers to a crystalline ionic compound in which there are two different anions and/or cations.
Engel's salt: As used herein, the term “Engle's salt” refers to an ionic compound and mineral with the composition potassium bicarbonate magnesium carbonate tetrahydrate. It is represented by the chemical formula KHCO₃·MgCO₃·4H₂O. It is a hydrated double salt consisting of potassium, magnesium, bicarbonate, and carbonate ions.
Nesquehonite: As used herein, the term “Nesquehonite” refers to an ionic compound and mineral with the composition magnesium carbonate trihydrate. It is represented by the chemical formula MgCO₃·3H₂O. Magnesium carbonate trihydrate (Nesquehonite) may be obtained from natural deposits via surface or underground mining followed by purification, precipitated from magnesium-rich brines by reaction with carbon dioxide or a carbonate source under controlled pH and temperature, or produced synthetically, for example, by carbonation of magnesium hydroxide or magnesium chloride solutions.
Basic Magnesium Carbonate: As used herein, the term “basic magnesium carbonate” refers to a range of hydrous magnesium carbonate-based ionic compounds and minerals with the general composition of aMgCO₃·bMg(OH)₂·cH₂O. This form of magnesium carbonate is not active towards the formation of Engel's salt but may form during the leaching of Engel's salt in water if the temperature exceeds 70° C. or other conditions apply in which dissolved CO₂ is removed from solution, as by applying vacuum. Specific forms of this compound include hydromagnesite 4MgCO₃·1Mg(OH)₂·4H₂O, artinite 1MgCO₃·1Mg(OH)₂·3H₂O, or dypingite 4MgCO₃·1Mg(OH)₂·5H₂O.
Crystallization Unit: As used herein, the term “crystallization unit” refers to a process vessel or system of vessels designed to facilitate the controlled formation of solid crystals from a solution through manipulation of temperature, concentration, and other thermodynamic parameters. In the context of the present disclosure, the crystallization unit is specifically configured to combine potassium chloride, sodium bicarbonate, and magnesium carbonate trihydrate in an aqueous solution and subsequently cool the solution to promote the selective crystallization of Engel's salt comprising potassium bicarbonate magnesium carbonate tetrahydrate. The crystallization unit operates by creating supersaturation conditions that favor the nucleation and growth of the desired double salt while maintaining other components in solution.

The crystallization unit may be embodied in various configurations depending on the scale of operation and specific process requirements. In one embodiment, the crystallization unit comprises a jacketed stirred tank reactor equipped with external cooling circuits utilizing chilled water, glycol solutions, or refrigeration systems to achieve the target temperature range of 0° C. to 20° C. The vessel may incorporate baffles and agitation systems including pitched blade turbines, marine propellers, or anchor impellers to ensure adequate mixing and heat transfer while preventing excessive crystal breakage. Alternative embodiments include forced circulation crystallizers where the solution is continuously circulated through external heat exchangers to maintain uniform temperature distribution and crystal size distribution. Draft tube crystallizers represent another embodiment where internal circulation is achieved using an internal impeller, which circulates the slurry through a draft tube and surrounding baffle to promote the growth of larger crystals.

For larger scale operations, the crystallization unit may comprise multiple vessels arranged in series or parallel configuration to optimize residence time distribution and crystal quality. Continuous crystallization systems may incorporate mixed suspension mixed product removal (MSMPR) crystallizers with controlled feed and discharge streams to maintain steady-state operation. Fluidized bed crystallizers represent an alternative embodiment where crystals are maintained in suspension through upward fluid flow, promoting uniform crystal growth and minimizing agglomeration.

The crystallization unit may further incorporate advanced process control systems including temperature controllers, pH monitoring equipment, conductivity meters, and turbidity sensors to monitor crystallization progress and maintain optimal conditions. Seeding systems may be integrated to control nucleation and achieve desired crystal size distributions.

Commercial sources for potassium chloride suitable for use in the crystallization unit include (but are not limited to) fertilizer grade, industrial/technical grade, or pharmaceutical grade potassium chloride. Such potassium chloride may be obtained from mined sylvite or carnallite deposits via conventional underground mining, surface mining, or solution mining processes, or produced synthetically, for example, by neutralization of potassium hydroxide with hydrochloric acid. These commercial sources typically provide potassium chloride with purity levels ranging from about 95% to about 99% by weight KCl.

Commercial sources of sodium bicarbonate suitable for use in the crystallization unit include, but are not limited to, feed grade, food grade, pharmaceutical grade, or industrial/technical grade material. Such sodium bicarbonate may be produced from mined trona or nahcolite via conventional underground mining, surface mining, or solution mining followed by crystallization, or produced synthetically, for example, via the Solvay process by reacting sodium chloride, ammonia, and carbon dioxide in aqueous solution. These commercial sources typically provide sodium bicarbonate having a purity of about 95% to about 99.9% by weight sodium NaHCO₃.

Commercial sources of magnesium chloride suitable for optional use in the crystallization unit include, but are not limited to, fertilizer grade, industrial/technical grade, food grade, or pharmaceutical grade material in solid form (anhydrous or hydrated, e.g. MgCl₂·6H₂O) or as commercial brines containing about 20% to about 35% by weight MgCl₂. Such magnesium chloride may be produced from mined carnallite or bischofite via conventional underground mining, surface mining, or solution mining processes followed by evaporation and/or crystallization. Magnesium chloride may also be produced from seawater, brine lakes, or salt wells via solar evaporation, mechanical evaporation, and/or crystallization. Magnesium chloride may also be produced synthetically, for example, by reaction of magnesium hydroxide or magnesium carbonate with hydrochloric acid. These commercial sources typically provide magnesium chloride with a purity of about 95% to about 99% by weight MgCl₂ on an anhydrous basis (for solids) or about 20% to about 35% by weight MgCl₂ (for brines).

Separation Unit: As used herein, the term “separation unit” refers to a process apparatus or system of interconnected equipment designed to physically separate solid Engel's salt crystals from the aqueous solution following crystallization, while simultaneously removing residual mother liquor and soluble impurities through controlled washing operations. In the context of the present disclosure, the separation unit is specifically configured to isolate Engel's salt comprising potassium bicarbonate magnesium carbonate tetrahydrate from the crystallization mixture while producing a clarified filtrate containing primarily sodium chloride in aqueous solution. The separation unit operates through solid-liquid separation mechanisms that may include filtration, centrifugation, sedimentation, or combinations thereof, followed by displacement washing to achieve the desired purity of the separated Engel's salt.

The separation unit may be embodied in various configurations depending on the scale of operation, crystal characteristics, and process requirements. In one embodiment, the separation unit comprises a Nutsche filter equipped with a perforated plate or filter medium such as polypropylene cloth, stainless steel mesh, or ceramic filter elements. The Nutsche filter operates under vacuum or pressure differential to draw the mother liquor through the filter medium while retaining the Engel's salt crystals on the filter surface. The unit incorporates spray nozzles or distribution systems for controlled addition of wash water to displace residual sodium chloride solution from the crystal bed. Temperature control systems maintain the wash water at optimal temperatures, typically between 0° C. and 10° C. to prevent dissolution of Engel's salt during the washing process.

Alternative embodiments include plate and frame filter presses where the crystallization slurry is pumped into chambers formed between alternating plates and frames, with filter cloths separating the solid and liquid phases. The filter press configuration allows for high-pressure operation and efficient cake washing through controlled displacement of the mother liquor with fresh wash water. Horizontal belt filters represent another embodiment where the slurry is continuously fed onto a moving perforated belt, with vacuum applied from beneath to draw the filtrate through the belt while the solids are conveyed forward for washing and discharge. This configuration is particularly suitable for continuous operation and high throughput applications.

Rotary vacuum filters constitute an alternative embodiment where a rotating drum partially submerged in the crystallization slurry picks up a layer of crystals on its perforated surface. As the drum rotates, vacuum is applied to draw the mother liquor through the filter medium, followed by wash water application and final dewatering before the crystals are discharged by compressed air or mechanical scraping. The rotary vacuum filter provides continuous operation with automatic cake formation, washing, and discharge cycles.

Centrifugal separation units represent another embodiment where the crystallization slurry is fed into a rotating basket or bowl, with centrifugal force driving the mother liquor through the perforated basket wall while retaining the crystals. Basket centrifuges operate in batch mode with controlled acceleration and deceleration cycles to optimize separation efficiency and crystal integrity. The unit incorporates spray systems for wash water application during the spin cycle, followed by high-speed dewatering to minimize residual moisture content. Pusher centrifuges provide continuous operation where crystals are continuously fed, separated, washed, and discharged through axial movement of a pusher plate.

Solid bowl centrifuges offer an alternative continuous separation approach where the slurry is fed into a rotating conical bowl, with the heavier crystals settling against the bowl wall and being conveyed by a scroll conveyor toward the discharge end. The clarified mother liquor overflows at the opposite end of the bowl. This configuration allows for continuous processing of high solids content slurries with minimal operator intervention.

Hydrocyclone separators may be employed as a preliminary separation step where the crystallization slurry is fed tangentially into a conical vessel, creating a vortex that separates particles based on size and density differences. The coarser Engel's salt crystals report to the underflow while the finer particles and mother liquor exit through the overflow. Multiple hydrocyclones may be arranged in parallel or series configurations to optimize separation efficiency.

Countercurrent decantation systems represent another embodiment where multiple thickener tanks are arranged in series, with the crystallization slurry fed to the first thickener and wash water fed to the last thickener. The overflow from each thickener becomes the feed to the previous thickener, creating a countercurrent flow pattern that maximizes washing efficiency while minimizing wash water consumption. Gravity settling in each thickener allows for natural separation of the crystals from the aqueous phase.

The separation unit may incorporate advanced process control systems including differential pressure transmitters to monitor filter resistance and optimize backwash cycles, turbidity meters to assess filtrate clarity, and conductivity analyzers to monitor washing efficiency. Automated valve systems control the sequencing of filtration, washing, and discharge operations to maintain consistent product quality and maximize throughput.

Leaching Unit: As used herein, the term “leaching unit” refers to a process apparatus or system of interconnected equipment designed to facilitate the controlled decomposition of Engel's salt in water to yield aqueous potassium bicarbonate and solid magnesium carbonate trihydrate (Nesquehonite). In the context of the present disclosure, the leaching unit is specifically configured to maintain optimal temperature conditions between 40° C. and 70° C. while providing sufficient mixing and residence time to achieve complete decomposition of Engel's salt, while preventing the formation of undesirable basic magnesium carbonate compounds.

The leaching unit may be embodied in various configurations depending on the scale of operation and process requirements. In one embodiment, the leaching unit comprises a jacketed stirred tank reactor equipped with heating circuits utilizing steam, hot water, or electrical heating elements to maintain the target temperature range. The vessel incorporates baffles and agitation systems including pitched blade turbines, hydrofoil impellers, or anchor agitators to ensure uniform temperature distribution and solids suspension while minimizing crystal attrition. Temperature control systems maintain precise temperature regulation to prevent the formation of basic magnesium carbonate above 70° C.

Alternative embodiments include continuous stirred tank reactors (CSTR) arranged in series where the Engel's salt slurry flows through multiple vessels with controlled residence time to achieve complete decomposition. Each vessel maintains independent temperature control and agitation systems. Draft tube crystallizers represent another embodiment where internal circulation is achieved using an internal impeller, which circulates the slurry through a draft tube and surrounding baffle to promote the growth of larger crystals.

For larger scale operations, the leaching unit may comprise multiple vessels arranged in series or parallel configuration to optimize residence time distribution and decomposition efficiency. Continuous leaching systems may incorporate plug flow reactors with static mixers or structured packing to promote intimate contact between the Engel's salt and water phase while maintaining temperature control through external heat exchange circuits.

Method for Extracting Potassium Bicarbonate from Mineral Mixtures

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a method and system for extracting potassium bicarbonate from mineral mixtures, specifically from a mixture of potassium chloride and sodium bicarbonate. This method utilizes a unique approach involving the formation of Engel's salt, or potassium bicarbonate magnesium carbonate tetrahydrate. The formation of this Engel's salt is facilitated by the use of magnesium carbonate trihydrate, also known as Nesquehonite, and the process operates under ambient pressure and temperature conditions, thereby reducing the energy requirements typically associated with potassium bicarbonate production.

In some aspects, the method includes the steps of combining the mineral mixture in an aqueous solution, cooling the solution to form Engel's salt, separating Engel's salt from the solution, and then leaching Engel's salt with water to produce an aqueous potassium bicarbonate solution and recover the Nesquehonite for reuse in subsequent extraction cycles. This cyclical process minimizes waste and enhances the overall efficiency of the method.

In other aspects, the system designed to implement this method includes a crystallization unit, a separation unit, and a leaching unit. These units work in concert to facilitate the formation, separation, and decomposition of Engel's salt, ultimately yielding the desired potassium bicarbonate product.

This novel approach to potassium bicarbonate extraction offers several potential advantages. For instance, it leverages naturally occurring minerals, thereby reducing reliance on synthetic precursors. It also operates under mild conditions, which may result in energy savings and a lower environmental impact. Furthermore, the method yields a high-purity potassium bicarbonate product, which may be suitable for various applications in industries such as agriculture, food production, and personal care products.

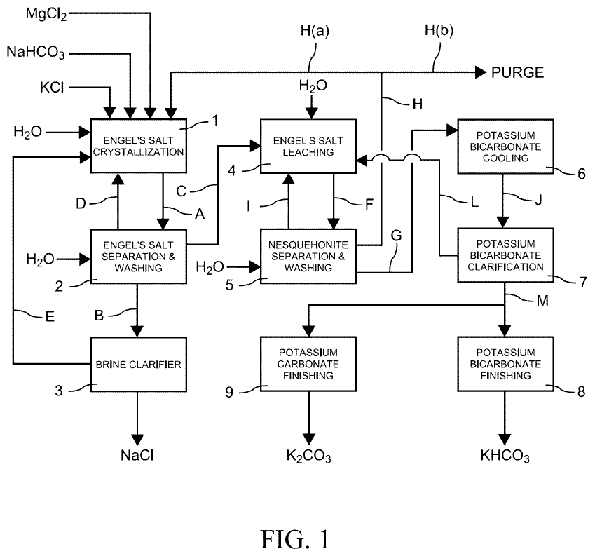

Referring to FIG. 1, the initial stages of the potassium bicarbonate extraction process involve the Engel's Salt Crystallization System 1 and the Engel's Salt Separation and Washing System 2. In some aspects, the Engel's Salt Crystallization System 1 combines potassium chloride, sodium bicarbonate, and magnesium carbonate trihydrate in an aqueous solution. This mixture may be cooled to a temperature between 0° C. and 20° C., which facilitates the formation of Engel's salt comprising potassium bicarbonate magnesium carbonate tetrahydrate, also known as Engel's salt.

In some cases, the Engel's Salt Crystallization System 1 may also include a mechanism for adding magnesium chloride to the aqueous solution. The addition of magnesium chloride can enhance the formation of Engel's salt and contribute to the overall efficiency of the process.

Following the formation of Engel's salt, the mixture is directed to Engel's Salt Separation and Washing System 2. This system is configured to separate Engel's salt from the aqueous solution, yielding a solid Engel's salt and a filtrate. The filtrate, which primarily consists of sodium chloride dissolved in water, can be further processed or discarded as waste.

In some aspects, the Engel's Salt Separation and Washing System 2 may also include a mechanism for washing the separated Engel's salt with water. This washing step can help to remove any residual sodium chloride or other impurities from Engel's salt, thereby enhancing the purity of Engel's salt.

Once Engel's salt has been separated and washed, it can be directed to a leaching unit for further processing. In some cases, the leaching unit may be configured to leach Engel's salt with water to produce an aqueous potassium bicarbonate solution and magnesium carbonate trihydrate. This leaching process effectively decomposes Engel's salt, releasing the potassium bicarbonate and allowing for the recovery of the magnesium carbonate trihydrate.

In some aspects, the leaching process may involve heating Engel's salt and water to a temperature between 40° C. and 70° C. This elevated temperature can facilitate the decomposition of Engel's salt and enhance the efficiency of the leaching process.

In some cases, the magnesium carbonate trihydrate produced from the leaching process may be recycled back into the Engel's Salt Crystallization System 1 for use in subsequent extraction cycles. This recycling step can help to minimize waste and enhance the overall efficiency of the potassium bicarbonate extraction process.

Continuing with the description of the process illustrated in FIG. 1, the separated Engel's salt is directed to the Engel's Salt Leaching System 4. In some aspects, the Engel's Salt Leaching System 4 may include a mechanism for combining Engel's salt with water and a recycled stream of Engel's salt. This mixture may be heated to a temperature between 40° C. and 70° C., which facilitates the leaching of Engel's salt. During this leaching process, Engel's salt decomposes to yield an aqueous potassium bicarbonate solution and magnesium carbonate trihydrate, also known as Nesquehonite.

In some cases, the leaching process may be performed at atmospheric pressure, further contributing to the energy efficiency of the method. The resulting aqueous potassium bicarbonate solution may be directed to subsequent processing steps for further purification or conversion into a desired product form.

Following the leaching process, the mixture may be directed to the nesquehonite separation and washing system 5. In some aspects, this system may be configured to separate the Nesquehonite from the aqueous potassium bicarbonate solution. This separation process may involve washing the Nesquehonite with water to remove any residual potassium bicarbonate or other impurities. The resulting filtrate, which primarily consists of aqueous potassium bicarbonate, can be further processed or used as a product.

In some cases, a portion of the separated Nesquehonite may be recycled back into the Engel's Salt Crystallization System 1 via stream H(a) for use in subsequent extraction cycles. This recycling step can help to minimize waste and enhance the overall efficiency of the potassium bicarbonate extraction process. Additionally, a portion of the recycled Nesquehonite, ranging from 0-100%, may be purged from the system via stream H(b). This purging step can help to maintain the balance of materials in the system and prevent the accumulation of impurities. Those of skill in the art will recognize that the recycled portion can include 0%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 100%, and values in between. In various embodiments, the recycled portion can include 0%, 1%, 2%, 3%, 4%, 5%, 6%, 7%, 8%, 9%, 10%, 11%, 12%, 13%, 14%, 15%, 16%, 17%, 18%, 19%, and 20%.

In some aspects, the aqueous potassium bicarbonate solution may be directed to the potassium bicarbonate cooling system 6. This system may be configured to cool the solution to a temperature between 0-30° C. During this cooling process, a small amount of Engel's salt may crystallize from the solution. This crystallized Engel's salt can be separated and recycled back to the Engel's Salt Leaching System 4 for further processing.

In some cases, the cooled aqueous potassium bicarbonate solution may be directed to the potassium bicarbonate clarification system 7. This system may be configured to clarify the solution, yielding an aqueous potassium bicarbonate solution and a recycled stream of Engel's salt. The clarified potassium bicarbonate solution may be directed to the potassium bicarbonate finishing system 8 for further processing into a desired product form.

Referring to FIG. 1, the aqueous potassium bicarbonate solution produced by the nesquehonite separation and washing system 5 may be directed to the potassium bicarbonate cooling system 6. In some aspects, the potassium bicarbonate cooling system 6 may be configured to cool the solution to a temperature between 0-30° C. During this cooling process, a small amount of Engel's salt may crystallize from the solution. This crystallized Engel's salt can be separated and recycled back to the Engel's Salt Leaching System 4 for further processing.

In some cases, the cooled aqueous potassium bicarbonate solution may be directed to the potassium bicarbonate clarification system 7. This system may be configured to clarify the solution, yielding an aqueous potassium bicarbonate solution and a recycled stream of Engel's salt. The clarified potassium bicarbonate solution may be directed to the potassium bicarbonate finishing system 8 for further processing into a desired product form.

The potassium bicarbonate finishing system 8 may be configured to process the aqueous potassium bicarbonate solution to produce a potassium bicarbonate product. In some aspects, the potassium bicarbonate product may be in the form of an aqueous solution. In other cases, the potassium bicarbonate product may be a crystallized solid. In yet other cases, the potassium bicarbonate product may be a spray-dried powder. The specific form of the potassium bicarbonate product may depend on the specific requirements of the end use application.

In some aspects, the system may also include a potassium carbonate finishing system 9. This system may be configured to process a portion of the output from the potassium bicarbonate clarification system 7 to produce potassium carbonate products. The potassium carbonate finishing system 9 may include mechanisms for converting bicarbonate ions to carbonate ions, such as by heating the solution to boiling to strip off carbon dioxide, or by heating dry potassium bicarbonate to between 150° C. and 200° C.

In some cases, the potassium bicarbonate and potassium carbonate products produced by the system may be suitable for various applications in industries such as agriculture, food production, and personal care products. The high purity of these products, combined with the environmentally friendly and efficient process used to produce them, may provide significant advantages over traditional methods of potassium bicarbonate and potassium carbonate production.

Referring to FIG. 1, the Engel's Salt Crystallization System 1 may be configured to cool the aqueous solution to a temperature between 0° C. and 20° C. This cooling step facilitates the formation of Engel's salt, which comprises potassium bicarbonate magnesium carbonate tetrahydrate, also known as Engel's salt. The cooling temperature range may be selected based on factors such as the specific composition of the mineral mixture, the desired rate of Engel's salt formation, and the energy efficiency considerations.

In some aspects, the Engel's Salt Crystallization System 1 may also include a magnesium chloride addition unit. This unit may be configured to add magnesium chloride to the aqueous solution. The addition of magnesium chloride can enhance the formation of Engel's salt and contribute to the overall efficiency of the process. The amount of magnesium chloride added may be determined based on factors such as the concentration of the other components in the solution and the desired rate of Engel's salt formation.

Following the formation of Engel's salt, the mixture may be directed to the Engel's Salt Leaching System 4. In some cases, the Engel's Salt Leaching System 4 may be configured to heat Engel's salt and water to a temperature between 40° C. and 70° C. This elevated temperature facilitates the decomposition of Engel's salt, releasing the potassium bicarbonate and allowing for the recovery of the magnesium carbonate trihydrate, also known as Nesquehonite. The specific temperature range for the leaching process may be selected based on factors such as the desired rate of Engel's salt decomposition, the stability of the components in the mixture, and energy efficiency considerations.

In some aspects, the system may also include a recycling unit configured to recycle at least a portion of the magnesium carbonate trihydrate produced from the leaching process back into the Engel's Salt Crystallization System 1. This recycling step can help to minimize waste and enhance the overall efficiency of the potassium bicarbonate extraction process. The amount of magnesium carbonate trihydrate recycled may be determined based on factors such as the desired rate of Engel's salt formation, the concentration of the other components in the solution, and the overall balance of materials in the system.

In some cases, the system may also include a purge unit configured to purge 0-100% of the recycled magnesium carbonate trihydrate. This purging step can help to maintain the balance of materials in the system and prevent the accumulation of impurities. The specific percentage of magnesium carbonate trihydrate purged may be determined based on factors such as the concentration of impurities in the system, the overall balance of materials in the system, and the desired purity of the final potassium bicarbonate product.

Referring to FIG. 1, the filtrate B from the Engel's Salt Separation and Washing System 2, which primarily consists of sodium chloride dissolved in water, is directed to the brine clarifier 3. In some aspects, the brine clarifier 3 may be configured to separate fine solids from the filtrate B. This separation process can help to remove any residual Engel's salt or other impurities from the filtrate, thereby enhancing the purity of the sodium chloride solution. The clarified sodium chloride solution may be further processed or used as a product. In some cases, the brine clarifier 3 may also produce a solid stream E consisting primarily of Engel's salt, which is recycled back to the Engel's Salt Crystallization System 1 for further processing.

The Engel's salt stream C from the Engel's Salt Separation and Washing System 2 is directed to the Engel's Salt Leaching System 4. In some aspects, the Engel's Salt Leaching System 4 may include a mechanism for combining Engel's salt with water, wash rinse stream I, and a recycled stream of Engel's salt. This mixture may be heated to a temperature between 40° C. and 70° C., which facilitates the leaching of Engel's salt. During this leaching process, Engel's salt decomposes to yield an aqueous potassium bicarbonate solution and magnesium carbonate trihydrate, also known as Nesquehonite.

In some cases, the Engel's Salt Leaching System 4 may be configured to operate at atmospheric pressure. This operating condition can contribute to the energy efficiency of the method and reduce the overall operational complexity of the system. The resulting aqueous potassium bicarbonate solution may be directed to subsequent processing steps for further purification or conversion into a desired product form.

Following the leaching process, the mixture F is directed to the nesquehonite separation and washing system 5. In some aspects, this system may be configured to separate the Nesquehonite from the aqueous potassium bicarbonate solution. This separation process may involve washing the Nesquehonite with water to remove any residual potassium bicarbonate or other impurities. The resulting filtrate G, which primarily consists of aqueous potassium bicarbonate, can be further processed or used as a product.

In some cases, a portion of the separated Nesquehonite may be recycled back into the Engel's Salt Crystallization System 1 via stream H(a) for use in subsequent extraction cycles. This recycling step can help to minimize waste and enhance the overall efficiency of the potassium bicarbonate extraction process. Additionally, a small portion of the recycled Nesquehonite, ranging from 0-20%, may be purged from the system via stream H(b). This purging step can help to maintain the balance of materials in the system and prevent the accumulation of impurities.

The aqueous potassium bicarbonate solution G is directed to the potassium bicarbonate cooling system 6. In some aspects, the potassium bicarbonate cooling system 6 may be configured to cool the solution to a temperature between 0-30° C. During this cooling process, a small amount of Engel's salt may crystallize from the solution. This crystallized Engel's salt can be separated and recycled back to the Engel's Salt Leaching System 4 for further processing.

The cooled aqueous potassium bicarbonate solution is directed to the potassium bicarbonate clarification system 7. This system may be configured to clarify the solution, yielding an aqueous potassium bicarbonate solution M and a recycled stream of Engel's salt L. The clarified potassium bicarbonate solution may be directed to the potassium bicarbonate finishing system 8 for further processing into a desired product form.

The potassium bicarbonate finishing system 8 may be configured to process the aqueous potassium bicarbonate solution to produce a potassium bicarbonate product. In some aspects, the potassium bicarbonate product may be in the form of an aqueous solution. In other cases, the potassium bicarbonate product may be a crystallized solid. In yet other cases, the potassium bicarbonate product may be a spray-dried powder. The specific form of the potassium bicarbonate product may depend on the specific requirements of the end use application.

Referring to FIG. 1, the aqueous potassium bicarbonate solution produced by the nesquehonite separation and washing system 5 is directed to the potassium bicarbonate cooling system 6. In some aspects, the potassium bicarbonate cooling system 6 may be configured to cool the solution to a temperature between 0-30° C. This cooling step can facilitate the crystallization of a small amount of Engel's salt from the solution. The crystallized Engel's salt can be separated and recycled back to the Engel's Salt Leaching System 4 for further processing.

The cooled aqueous potassium bicarbonate solution is then directed to the potassium bicarbonate clarification system 7. This system may be configured to clarify the solution, yielding an aqueous potassium bicarbonate solution and a recycled stream of Engel's salt. The clarified potassium bicarbonate solution may be directed to the potassium bicarbonate finishing system 8 for further processing into a desired product form.

In some cases, the potassium bicarbonate finishing system 8 may be configured to process the aqueous potassium bicarbonate solution to produce a potassium bicarbonate product. The specific form of the potassium bicarbonate product may depend on the specific requirements of the end use application. For instance, in some aspects, the potassium bicarbonate product may be in the form of an aqueous solution. In other cases, the potassium bicarbonate product may be a crystallized solid. In yet other cases, the potassium bicarbonate product may be a spray-dried powder. Each of these product forms may have specific advantages depending on the intended use. For example, a crystallized solid or spray-dried powder form of potassium bicarbonate may be more suitable for applications that require a dry product, such as certain agricultural or food production applications.

In addition to the potassium bicarbonate finishing system 8, the system may also include a potassium carbonate finishing system 9. This system may be configured to process a portion of the output from the potassium bicarbonate clarification system 7 to produce potassium carbonate products. The potassium carbonate finishing system 9 may include mechanisms for converting bicarbonate ions to carbonate ions, such as by heating the solution to boiling to strip off carbon dioxide, or by heating dry potassium bicarbonate to between 150° C. and 200° C. The resulting potassium carbonate products may be suitable for various applications in industries such as agriculture, food production, and personal care products.

In some aspects, the aqueous potassium bicarbonate solution produced by the method and system described herein may have a concentration ranging from 5% to 15% by weight. This concentration range may be selected based on factors such as the specific requirements of the end use application, the desired purity of the final product, and the efficiency of the extraction process. For instance, a higher concentration of potassium bicarbonate may be desirable for applications that require a high-purity product, while a lower concentration may be sufficient for applications that can tolerate a lower purity product.

In some cases, the aqueous potassium bicarbonate solution may be further processed to produce a variety of potassium bicarbonate products. For example, the solution may be sold as-is, or it may be diluted or concentrated via evaporation to achieve a desired concentration. In other cases, the solution may be crystallized to yield dry potassium bicarbonate crystals. This crystallization process may involve various techniques known in the art, such as cooling the solution. In yet other cases, the solution may be spray dried to yield dry potassium bicarbonate powder. Each of these product forms may have specific advantages depending on the intended use. For instance, a crystallized solid or spray-dried powder form of potassium bicarbonate may be more suitable for applications that require a dry product, such as certain agricultural or food production applications.

For example, in some embodiments, the aqueous potassium bicarbonate solution produced by the nesquehonite separation and washing system 5 is further processed to produce crystalline solid potassium bicarbonate. This may be accomplished by several methods known in the art:
(1) Evaporative Crystallization: The aqueous potassium bicarbonate solution (typically 5-15% KHCO₃ by weight) is heated to evaporate water, concentrating the solution until the solubility limit is exceeded and KHCO₃ crystals form. This process may be carried out at atmospheric pressure at approximately 100° C., or under reduced pressure (vacuum evaporation) at lower temperatures (e.g., 40-80° C.) to reduce thermal degradation. The resulting crystal slurry is separated (by filtration or centrifugation) and the crystals are dried (e.g., in a fluid bed dryer or rotary dryer) to produce dry crystalline potassium bicarbonate.
(2) Cooling Crystallization: The aqueous potassium bicarbonate solution is cooled (e.g., to 0-10° C.) to reduce KHCO₃ solubility and induce crystallization. Because KHCO₃ solubility decreases with temperature, cooling a concentrated solution produces KHCO₃ crystals. This method may be combined with evaporation to first concentrate the solution before cooling.

The particle size, crystal habit, and purity of the solid KHCO, product can be controlled by adjusting crystallization conditions (supersaturation level, cooling/evaporation rate, seeding, agitation) according to methods known in the art.

Spray Drying of Potassium Bicarbonate: In some embodiments, the aqueous potassium bicarbonate solution is spray dried to produce a fine powder form. Spray drying involves atomizing the aqueous solution into fine droplets and contacting the droplets with heated gas (typically air at 120-200° C. inlet temperature) in a spray drying chamber. The rapid evaporation of water from the droplets produces solid KHCO₃ particles that are collected from the gas stream using cyclones, bag filters, or electrostatic precipitators. Spray-dried KHCO₃ typically has smaller particle size and higher surface area compared to crystallized product, which may be advantageous for certain applications (e.g., rapid dissolution in beverages or pharmaceutical formulations). Spray drying parameters (inlet/outlet temperatures, atomization method, feed rate, air flow) are selected based on desired particle size, moisture content, and bulk density according to methods known in spray drying art.

Aqueous Solution Product: In some embodiments, the aqueous potassium bicarbonate solution is sold or used directly as a liquid product without further processing. The solution concentration may be adjusted (by dilution with water or concentration by evaporation) to a desired level depending on application requirements. For example, aqueous KHCO₃ solutions at 5-20% concentration may be used in agriculture as liquid fertilizers, in industrial applications as pH regulators or cleaning agents, or in food processing. The aqueous solution may be stabilized (e.g., by addition of small amounts of potassium carbonate to buffer pH) and packaged in suitable containers.

In some aspects, the system may be modified to accommodate different processing options or to enhance the efficiency of the potassium bicarbonate extraction process. For example, the system may include additional units or mechanisms for controlling the temperature, pressure, or other conditions of the process. The system may also include additional units or mechanisms for purifying the aqueous potassium bicarbonate solution or the final product. These modifications may be implemented based on factors such as the specific requirements of the end use application, the desired purity of the final product, and the efficiency of the extraction process.

In some embodiments, potassium chloride may be substituted for other soluble potassium salts, including natural potassium sulfate (alone or in double salts of magnesium potassium sulfate such as Langbeinite or Leonite). Although naturally occurring materials are presented, those of skill in the art will recognize that other synthetic and soluble potassium salts such as potassium acetate or potassium nitrate could be utilized.

Sodium bicarbonate may be substituted in part with natural Trona (double salt of sodium carbonate bicarbonate dihydrate), especially when trona is combined with magnesium potassium sulfate double salt Langbeinite to form Engel's salt directly by the following equation:

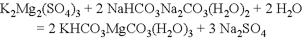

Trona can also be substituted in part for the step in which magnesium chloride is used to produce additional Nesquehonite as make up, in which case magnesium chloride, potassium chloride, and Trona combine to form Engel's salt and sodium chloride per the following equation:

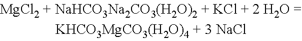

Magnesium chloride may be substituted for other soluble magnesium salts, including magnesium sulfate heptahydrate (Epsom Salt) or in magnesium potassium sulfate double salts such as Langbeinite or Leonite.

In other embodiments, the Brine Clarifier step is eliminated, and stream B may be utilized for sale directly, or stream E is taken directly from the Engel's salt Separation and Washing step and recycled to the Engel's salt Crystallization step without first clarifying the stream.

In other embodiments, the Potassium Bicarbonate Clarifier step and Stream L are eliminated and stream G may be utilized for sale directly, or processed into other products in the Potassium Bicarbonate Finishing or Potassium Carbonate Finished steps as previously discussed without first cooling and clarifying the stream.

In other embodiments, dilute wash stream D from the Engel's salt Separation and Washing step is combined with Brine stream B rather than recycled to the Engel's salt Crystallization step.

In other embodiments, dilute wash stream I from the Nesquehonite Separation and Washing step is combined with potassium bicarbonate stream G rather than recycled to the Engel's salt Leaching step.

In yet other embodiments, Engel's salt Crystallization can include the use of known systems such as a forced circulation crystallizer, jacketed/agitated vessel, or other methods known in the art, and Engel's salt Separation and Washing can be any method of separating solid/liquid slurries and washing the solids to remove residual aqueous salts, such as a Nutsche filter, Plate and Frame Filter, Horizontal Belt Filter, Rotary Vacuum Filter, Basket Centrifuge, Countercurrent decantation via gravity settling, solid bowl centrifuges, hydrocyclones, or other methods known in the art. Those of skill in the art will recognize various methods of implementing these alternatives in the Examples below.

In yet additional embodiments is a method in which the Nesquehonite does not recycle and instead MgCl₂, KCl, and NaHCO₃ (or materials from other embodiments, Trona instead of sodium bicarb, Langbeinite instead of MgCl₂ and KCl, etc.) are combined in the Engel's salt Crystallization step, processed through to Nesquehonite separation and washing, producing the same KHCO₃ stream and Nesquehonite stream, but instead Nesquehonite is directed to another use or saleable product.

### Crystallization Temperature

The temperature for Engel's salt crystallization (cooling the aqueous solution comprising KCl, NaHCO₃, and MgCO₃·3H₂O) is preferably selected in the range of 0° C. to 20° C., and in various embodiments 2° C. to 15° C., and in yet other embodiments 5° C. to 10° C. Lower temperatures within this range (closer to 0° C.) generally favor more complete crystallization of Engel's salt due to reduced solubility, resulting in higher conversion of potassium ion to Engel's salt. However, cooling to very low temperatures may increase refrigeration costs and may cause freezing if the solution is cooled below its freezing point (which depends on salt concentration). Higher temperatures within the range (closer to 20° C.) reduce refrigeration requirements but may result in lower conversion efficiency. The optimal temperature is selected based on economic considerations balancing yield versus energy costs. For industrial operations, temperatures of 5-10° C. typically provide good balance of high yield and reasonable energy consumption.

### Leaching Temperature

The temperature for leaching Engel's salt with water is preferably selected in the range of 40° C. to 70° C., and in various embodiments 50° C. to 65° C., and in yet other embodiments 55° C. to 65° C. Higher temperatures within this range (closer to 70° C.) generally favor faster dissolution of KHCO₃ from Engel's salt and higher yields, reducing leaching time required. However, temperatures exceeding 70° C. should be avoided because they may promote formation of basic magnesium carbonate compounds (such as hydromagnesite, artinite, or dypingite, as defined above), which are undesirable because they are less reactive for forming Engel's salt in subsequent cycles and are more difficult to filter. Temperatures below 40° C. result in slower leaching kinetics and incomplete decomposition of Engel's salt, reducing process efficiency. For industrial operations, temperatures of 55-65° C. typically provide optimal balance of rapid leaching, high yield, and avoidance of basic magnesium carbonate formation.

### Molar Ratios

The molar ratios of reactants in the Engel's salt crystallization step may be selected as follows:
(1) Water to Potassium Chloride Ratio: The molar ratio of water to potassium chloride is preferably in the range of 9.6 to 23.3, as recited above. In various embodiments, the ratio is 12 to 18, and in yet other embodiments 13 to 16. Lower water ratios (less water, more concentrated solutions) may result in higher viscosity slurries that are difficult to mix and filter, while higher water ratios (more dilute solutions) reduce volumetric productivity and increase energy costs for cooling larger volumes.
(2) Sodium Bicarbonate to Potassium Chloride Ratio: The molar ratio of sodium bicarbonate to potassium chloride is preferably in the range of 0.75 to 1.0, as recited above. A stoichiometric ratio of 1:1 (one mole NaHCO₃ per mole KCl) is expected. However, operating with slight deficiency of NaHCO₃ (ratio 0.75-0.95) may be economical because it reduces NaHCO₃ consumption and prevents excess unreacted NaHCO₃ from contaminating the NaCl byproduct stream. Alternatively, operating with slight excess of NaHCO₃ (ratio 1.0-1.1, or targeting 5-10% excess as mentioned above) may be preferred to ensure complete conversion of potassium ion to Engel's salt, maximizing yield even if some NaHCO₃ remains unreacted.
(3) Magnesium Carbonate Trihydrate to Potassium Chloride Ratio: The molar ratio of magnesium carbonate trihydrate (Nesquehonite) to potassium chloride is in the range of 0.75 to 2.0, as recited above, and in various embodiments 0.9 to 1.1, and in yet other embodiments 0.95 to 1.05. A stoichiometric ratio of approximately 1:1 is expected (one mole MgCO₃ per two moles KCl, thus 0.5:1, but allowing excess to drive reaction). Excess Nesquehonite (ratio>1.0) ensures sufficient magnesium carbonate is available for complete Engel's salt formation, although excess is recycled so there is minimal economic penalty.

### Mixing and Residence Time

The mixing time or residence time in the Engel's salt crystallization step (after all components have been combined and cooled) is preferably in the range of 2 to 24 hours as recited above, and in various embodiments 4 to 12 hours, and in yet other embodiments 4 to 8 hours. Longer residence times allow more complete crystallization and approach equilibrium, while shorter times reduce equipment size and capital cost. The mixing intensity should be sufficient to maintain solids in suspension (preventing settling) and promote mass transfer, but not so vigorous as to cause excessive crystal breakage or high energy consumption. Suitable mixing speeds for a laboratory-scale stirred vessel (e.g., 250 mL to 2 L beakers) are 200-600 RPM with overhead stirrers or magnetic stirrers. For industrial-scale stirred tanks (e.g., 1 m³ to 100 m³ vessels), mixing speeds of 30-150 RPM with pitched-blade turbines or marine propellers are typically suitable, corresponding to tip speeds of 1-3 m/s and power inputs of 0.5-2 kW/m³.

The leaching time in the Engel's salt leaching step is in the range of 15 minutes to over an hour as recited above, and in various embodiments 30 minutes to 90 minutes, and in yet other embodiments 45 minutes to 75 minutes. Leaching is generally faster than crystallization due to higher temperature, but sufficient time must be allowed for complete decomposition of Engel's salt. Mixing intensity should be sufficient to maintain solids in suspension and promote dissolution, with similar guidelines as for crystallization.

A number of implementations have been described. Nevertheless, it will be understood that various modifications may be made without departing from the spirit and scope of the disclosure. Accordingly, other implementations are within the scope of the following claims.

### EXAMPLES

Aspects of the present teachings may be further understood in light of the following examples, which should not be construed as limiting the scope of the present teachings in any way.

### Example 1—Potassium Bicarbonate Production

The process utilizes a carrier mineral called Nesquehonite, or magnesium carbonate trihydrate, to affect the separation of potassium bicarbonate from the potassium chloride and sodium bicarbonate mixture by selective crystallization of potassium in the form of Engel's salt, a double salt consisting of potassium bicarbonate magnesium carbonate tetrahydrate. Engel's salt is recovered from the mixture and mixed with water, whereby potassium bicarbonate leaches from Engel's salt to form an aqueous potassium bicarbonate solution, and the magnesium carbonate portion of Engel's salt reforms Nesquehonite, which is then recovered and used for subsequent extraction batches. In each cycle, some portion of the Nesquehonite is removed and discarded, and an equivalent magnesium amount is added in the form of magnesium chloride to maintain a constant inventory of Nesquehonite in the process. In the process, no chemical change occurs to the ionic species present in the raw materials, and thus the overall process is effectively a double replacement or metathesis between potassium chloride and sodium bicarbonate to yield sodium chloride and potassium bicarbonate. In addition, the process does not require any forcing conditions or other that may constitute a synthetic process, with the process temperature ranging from 0° C. to 70° C. and at ambient pressure only.

The two products of the process are aqueous potassium bicarbonate at a concentration ranging from 3% to 15% and a sodium chloride solution with concentration ranging from 10% to 25%. The aqueous potassium bicarbonate solution may be sold as a liquid (as-is, diluted, or concentrated via evaporation), crystallized to yield dry potassium bicarbonate crystals (by other means known in the art), or spray dried to yield dry potassium bicarbonate powder. Likewise, the sodium chloride solution may be sold as a liquid (as-is, diluted, or concentrated via evaporation) or crystallized to yield dry sodium chloride crystal. The uses for this sodium chloride byproduct are manifold and known in the art.

The potassium bicarbonate product may also be processed into potassium carbonate by heating the aqueous product to boiling, whereby carbon dioxide is stripped from the solution yielding aqueous potassium carbonate, or by heating dry potassium bicarbonate to between 150° C. to 200° C., analogous to the preparation of sodium carbonate from sodium bicarbonate.

Examples leading to the development of this work is related to an outdated method of producing potassium carbonate or bicarbonate called the Engel-Precht process (See, e.g., U.S. Pat. Nos. 1,967,630, and 2,020,801, each of which is incorporated herein by reference in its entirety). In this process, a mixture of aqueous potassium chloride and solid magnesium carbonate trihydrate (Nesquehonite) is contacted with gaseous carbon dioxide at low temperature (0 to 30° C.) and elevated pressure (5 to 150 psig), whereby Engel's salt is formed, and a portion of the Nesquehonite reacts to form aqueous magnesium chloride per the following reaction:

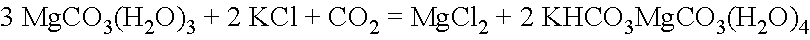

The formed Engel's salt is then leached in water in a manner described previously (See, e.g., U.S. Pat. No. 2,045,203 incorporated herein by reference in its entirety, and Noncatalytic Heterogeneous Kinetics in the Engel-Precht Potassium Carbonate Process Smithson and Bakhshi 1976).

A major drawback of this process is that half of the magnesium by mole is converted into magnesium chloride during the first reaction. While magnesium chloride is a useful product, the magnesium must be replaced by Nesquehonite to feed the first reaction, requiring substantial makeup of material into the process—or a means of converting magnesium chloride back into Nesquehonite by various means. In some cases, is has been described that the Nesquehonite is produced by carbonation of magnesium oxide, which is produced by calcination of magnesium carbonate bearing minerals (Nesquehonite is a hydrated magnesium carbonate-anhydrous magnesium carbonate is not active towards the crystallization of Engel's salt).

An improvement to the Engel-Precht process is described in U.S. Pat. No. 2,905,529, wherein potassium chloride and Nesquehonite are contacted in the presence of a primary, secondary, or tertiary alkyl amine and carbon dioxide, forming Engel's salt and an aqueous solution of amine chloride, which can be recovered as the free amine and recycled to the Engel's salt formation process by various methods.

The current invention improves upon the original Engel-Precht process in that the bicarbonate required to form Engel's salt is supplied by sodium bicarbonate, thus the products of crystallization are aqueous sodium chloride (as opposed to magnesium chloride) and Engel's salt (as described previously):

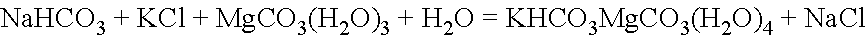

This has an additional benefit that elevated pressure is not required to drive the crystallization, as the sodium bicarbonate supplies a highly soluble bicarbonate ion without addition of carbon dioxide under pressure. Because nearly all the Nesquehonite used in Engel's salt crystallization is recovered and recycled, the amount of makeup Nesquehonite is extremely low and purging of the recycled Nesquehonite is required only to remove insoluble materials that occur naturally with the raw materials (specifically various insoluble minerals that occur as imporities in the raw materials, such as calcium carbonate, among others) or any basic magnesium carbonate that forms during the leaching of Engel's Salt. Magnesium chloride is added to the Engel's salt crystallization mixture to form Engel's salt by the formula:

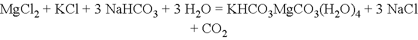

This formed Engel's salt then leaches potassium bicarbonate on the subsequent processing step to form Nesquehonite, which is recycled. Note this reaction provided in FIG. 1.

Water, recycle slurry E (described in FIG. 1), and Engel's salt wash rinse D (FIG. 1) are charged into the Engel's Salt Crystallization System 1. To the mixture, potassium chloride and sodium bicarbonate are added. Recycled magnesium carbonate trihydrate in the form of Nesquehonite H(a) and magnesium chloride are added. The entire mixture comprising the aforementioned is cooled to a temperature between 0 to 20° C. and maintained at atmospheric pressure. In this mixture, Engel's salt crystallizes leaving sodium chloride in solution per the following chemical equation:

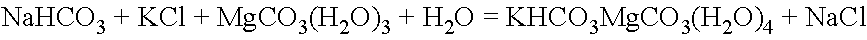

In this step, the molar ratio of water to potassium chloride at this step can be about 9.6 to about 23.3, and in various embodiments between 12.3 to 16.4. The molar ratio of sodium bicarbonate to potassium chloride at this step can be 0.75 to 1.0, and in various embodiments targeting 5-10% by mole excess of the expected conversion of potassium ion to Engel's salt. The molar ratio of magnesium carbonate trihydrate to potassium chloride at this step can be 0.75 to 2, and in various embodiments 0.9 to 1.1. Mixing time or residence time once all components have been mixed in this step ranges from about 2 hours to about 24 hours, and in various embodiments 4 to 8 hours.

Meanwhile, magnesium chloride and sodium bicarbonate form sodium chloride and magnesium carbonate trihydrate in the form of Nesquehonite per the following chemical equation:

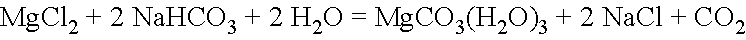

This formed Nesquehonite then participates in the first equation to form Engel's salt as mentioned above.

The mixture A is then separated and washed 2 with cold water to yield filtrate B which consists primarily of sodium chloride dissolved in water, solids consisting primarily of Engel's salt C, and a dilute wash water stream D which is recycled to the Engel's Salt Crystallization System 1.

Fine solids are separated from filtrate B in the brine clarifier 3, yielding a purified brine solution co-product stream and a solid stream E consisting primarily of Engel's salt which is recycled to the Engel's Salt Crystallization System 1.

Engel's salt stream C is combined with water, wash rinse stream I, and recycled Engel's salt stream L in the Engel's Salt Leaching System 4. The mixture is heated to 40 to 70° C. at atmospheric pressure, whereby aqueous potassium bicarbonate and solid magnesium carbonate trihydrate in the form of Nesquehonite are released per the following chemical reaction:

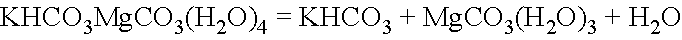

In this step, the molar ratio of water to Engel's Salt can be from about 31.5 to about 179.6, and in various embodiments between about 34.1 to about 50.0 to yield a potassium bicarbonate solution with a concentration of 10% to 14% by mass in water. The temperature should not exceed 70° C. to avoid the formation of basic magnesium carbonate solids, which are both difficult to filter and not active towards the formation of the Engel's salt. Mixing time or residence time once all components have been mixed in this step ranges from about 15 minutes to over an hour.

The potassium bicarbonate and Nesquehonite slurry F is separated and washed with cold water to yield filtrate G which consists of aqueous potassium bicarbonate, solids consisting primarily of magnesium carbonate trihydrate in the form of Nesquehonite H, and a dilute wash water stream I which is recycled to the Engel's Salt Leaching System 4. A majority of solid Nesquehonite stream H is recycled to the Engel's Salt Crystallization System 1 via stream H(a), with 0-20% being purged in stream H(b). Purged Nesquehonite is made up in the Engel's Salt Crystallization System 1 by addition of magnesium chloride, which forms Nesquehonite on combining with sodium bicarbonate as previously discussed.

Potassium bicarbonate stream G is cooled to 0-30° C. in the Potassium Bicarbonate Cooling System 6, upon which a small amount of Engel's salt crystallizes from the mixture. The slurry stream J is clarified to yield an aqueous potassium bicarbonate solution M and Engel's Salt Slurry Stream L, which is recycled to the Engel's Salt Leaching System 4.

Potassium bicarbonate stream M consists of aqueous potassium bicarbonate in water at concentration of 5-15% by weight. This stream may be processed 8 to yield various products including:
Direct sale of potassium bicarbonate solution in water
Evaporation of stream M to yield a more concentrated solution of potassium bicarbonate in water
Spray dried to yield a solid potassium bicarbonate product
Potassium bicarbonate crystallized from a concentrated aqueous potassium bicarbonate solution by cooling and/or addition of a suitable anti-solvent

In addition, aqueous potassium bicarbonate stream may be processed to yield various potassium carbonate products including:
Evaporation of stream M at such a temperature and/or pressure so as to convert bicarbonate ion to carbonate with loss of carbon dioxide to yield a concentrated solution of potassium carbonate
Recovery of potassium bicarbonate solids by crystallization or spray drying, followed by calcination at temperatures 350-450 F to yield solid potassium carbonate.

### Example 2

64.9 g of room-temperature water and 26.9 g of potassium chloride (OMRI-listed, commercial fertilizer grade) were added to a 250 ml beaker and stirred for 5 minutes using an overhead mixer fitted with a pitched-blade impeller to obtain a concentrated potassium chloride solution/slurry. To this mixture, 28.8 g of sodium bicarbonate (OMRI-listed, commercial food grade) was added and stirred for 5 minutes. Over 5 minutes, 65.9 g of nesquehonite (obtained by crystallization using methods known in the art, or alternatively, obtainable from natural materials or by leaching of Engel's salt) was added. The beaker was then cooled in an ice bath to around 5° C. while maintaining mixing for four hours. The slurry was then vacuum filtered using a Buchner funnel and the resulting solids were washed with 31.5 g of room-temperature water. After dewatering on the filter, the solids mass obtained was 108.9 g and analyzed 24.8% potassium as potassium bicarbonate. The conversion of potassium to Engel's salt was thus determined to be 78%. The combined filtrate and wash analyzed 16.1% sodium as sodium chloride, 2.9% potassium as potassium chloride, and 1.9% bicarbonate as sodium bicarbonate.

Next, an aqueous solution of potassium bicarbonate was recovered from the solids by leaching in water. 172.8 g of room-temperature water and 106.7 g of solids from the previous crystallization (containing 24.8% potassium bicarbonate) were added to a 500 mL beaker and stirred using an overhead mixer until well-dispersed. The beaker was placed on a hot plate and heated until the temperature of the mixture was 65° C., at which point the mixture was held at this temperature for 1 hour while continuing mixing. The resulting slurry was then filtered on a Buchner funnel and the solids washed with 41.6 g room-temperature water. The combined filtrate and wash mass was 231.1 g and analyzed 11.1% potassium as potassium bicarbonate. The potassium bicarbonate yield of this step was determined to be 97%.

### Example 3

An experiment was conducted to determine the optimum temperature and water concentration for precipitation of Engel's salt from a mixture of potassium chloride, sodium bicarbonate, nesquehonite, and water.

A crystallizer apparatus, comprising a 500 mL jacketed glass beaker and an overhead mixer with a pitched-blade impeller, was assembled. To the beaker, 103.8 g of room-temperature water was added, followed by 75.0 g of potassium chloride (OMRI-listed, commercial fertilizer grade). The mixture was stirred until the potassium chloride was dispersed into a concentrated solution/slurry (approximately 5 minutes). Next, 81.9 g of sodium bicarbonate (OMRI-listed, commercial food grade) was added to the beaker and stirred for 5 minutes. Over 10 minutes, 256.6 g of nesquehonite (assay 63%/balance water, obtained by crystallization using methods known in the art, or alternatively, obtainable from natural materials, or by leaching of potassium bicarbonate from Engel's salt) was added in 10 equal portions. The recirculating chiller was set to 25° C., and the mixture was stirred for 24 hours.

After 24 hours, a sample of the slurry was collected using a plastic syringe and filtered through a 0.1-micron syringe filter to isolate the liquid phase. Two 1.0 g samples were dispensed into two 50-mL vials. The contents of the first vial were quantitatively transferred to a beaker and analyzed by titration with 0.1 M HCl to determine bicarbonate concentration. The contents of the second vial were diluted to 50 g and analyzed by ion-selective electrode for sodium and potassium concentration. The conversion of potassium to Engel's salt was calculated to be 73%.

Subsequently, 60.12 g of water was added to the beaker, and the mixture was stirred at 25° C. for 24 hours. The slurry was again sampled and analyzed using the above method and the conversion of potassium to Engel's salt was determined to be 74%. The setpoint of the chiller was adjusted to 15° C. and the mixture stirred for 24 hours, giving a conversion of potassium to Engel's salt of 79%. The setpoint of the chiller was adjusted to 5° C. and the mixture stirred for 24 hours, giving a conversion of potassium to Engel's salt of 85%.

Next, 59.9 g of water was added to the beaker, and the mixture was stirred at 5° C. for 24 hours, giving a conversion of potassium to Engel's salt of 88%. The setpoint of the chiller was adjusted to 15° C. and the mixture stirred for 24 hours, giving a conversion of potassium to Engel's salt of 85%. The setpoint of the chiller was adjusted to 25° C. and the mixture stirred for 24 hours, giving a conversion of potassium to Engel's salt of 78%.

Next, 60.27 g of water was added to the beaker, and the mixture was stirred at 5° C. for 24 hours, giving a conversion of potassium to Engel's salt of 88%. The setpoint of the chiller was adjusted to 15° C. and the mixture stirred for 24 hours, giving a conversion of potassium to Engel's salt of 86%. The setpoint of the chiller was adjusted to 25° C. and the mixture stirred for 24 hours, giving a conversion of potassium to Engel's salt of 78%.

Finally, the slurry was transferred to a stainless-steel filter apparatus fitted with a 15-cm diameter, 1-micron polypropylene filter cloth. The apparatus was sealed, and compressed air at up to 2 barg was applied to separate the liquid phase (filtrate) from the solids, which were retained on the filter cloth. The filter apparatus was then depressurized, opened, and 50 g of room-temperature water poured evenly over the cake to rinse the solids of residual soluble salts. The filter apparatus was resealed, and compressed air at up to 2 barg was applied to rinse and dewater the solids. The rinse solution was collected in a separate container from the filtrate. Air flow then continued until no additional liquid droplets were observed leaving the filter. The mass of solids, filtrate, and rinse were recorded.

The filtrate and rinse samples were analyzed for sodium and potassium as previously described. The solids were analyzed by dissolving a 0.5 g sample in 15 mL of 5% acetic acid solution, then diluting to 50 mL with water. The potassium and sodium concentrations in the dissolved sample were analyzed by ion-selective electrode. The solids were found to contain 24.6% potassium as potassium bicarbonate.

The conversion of potassium to Engel's salt was found to increase with decreasing temperature and increasing water concentration, to a maximum observed conversion of 88% over the range of temperatures and water concentration measured. After the second water addition, further addition of water did not significantly impact the conversion of potassium to Engel's salt.

### Example 4

An experiment was conducted to determine the time required to achieve maximum conversion of potassium to Engel's salt based on the optimum concentration of materials determined in example 1. Compared to Example 2, the amount of nesquehonite addition was reduced by 78.4 g due to a suspected excess in the mixture. Also, the amount of sodium bicarbonate addition was reduced by 4.1 g due to the observation of some excess sodium bicarbonate in the solids.

A crystallizer apparatus, comprising a 500 mL jacketed glass beaker and an overhead mixer fitted with a pitched-blade impeller, was assembled. To the beaker, 233.3 g of room-temperature water was added, followed by 75.0 g of potassium chloride (OMRI-listed, commercial fertilizer grade). The mixture was stirred for 5 minutes until the potassium chloride was dispersed, forming a concentration solution. Next, 77.9 g of sodium bicarbonate (OMRI-listed, commercial food grade) was added to the beaker and stirred for 5 minutes. Over 10 minutes, 178.2 of nesquehonite (assay 63%/balance water, obtained by crystallization using methods known in the art, or alternatively, obtainable from natural materials or by leaching of Engel's salt) was added in 10 equal portions. The recirculating chiller was set to 5° C. and stirring continued.

Immediately after nesquehonite addition was concluded, an initial sample of the slurry was collected using plastic syringe and filtered through a 0.1-micron syringe filter to isolate the liquid phase. Two 1.0+/−0.1 g samples were dispensed into two 50-ml vials. The contents of the first vial were quantitatively transferred to a beaker and analyzed by titration with 0.1 M HCl to determine bicarbonate concentration. The contents of the second vial were diluted to 50 mL+/−1 mL and analyzed by ion-selective electrode for sodium and potassium concentration. The conversion of potassium to Engel's salt was calculated to be 3%.

After 50 minutes from the initial sample, the conversion of potassium to Engel's salt was calculated to be 4%. After 120 minutes from the initial sample, the conversion of potassium to Engel's salt was calculated to be 76%. After 178 minutes from the initial sample, the conversion of potassium to Engel's salt was calculated to be 81%. After 245 minutes from the initial sample, the conversion of potassium to Engel's salt was calculated to be 81%. After 330 minutes from the initial sample, the conversion of potassium to Engel's salt was calculated to be 81%.

Because the conversion after 330 minutes did not achieve the expected 88% conversion previously observed in Example 2, an additional 50 g of nesquehonite (assay 63%/balance water) was added after the sample at 330 minutes was taken. After 495 minutes from the initial sample (165 minutes after addition of 50 g nesquehonite), the conversion of potassium to Engel's salt was calculated to be 88%. After 610 minutes from the initial sample, the conversion of potassium to Engel's salt was calculated to be 88%. After 1,130 minutes from the initial sample, the conversion of potassium to Engel's salt was calculated to be 88%.

It was concluded from this experiment that the maximum conversion of potassium to Engel's salt is achieved in around 245 minutes. An induction period, where no appreciable conversion of potassium to Engel's salt takes place, was observed between 0-120 minutes. The lower conversion of potassium to Engel's salt observed at 330 minutes was attributed to a sub-optimal amount of nesquehonite in the mixture, despite the hypothesis that nesquehonite was in excess in the mixture from Example 2. Addition of 50 g of nesquehonite to the mixture at 330 minutes allowed the conversion of potassium to Engel's salt to proceed to the 88% observed previously in Example 2.

### Example 5

An additional experiment was conducted to determine if Engel's salt could be prepared in the absence of nesquehonite by crystallization directly from potassium chloride, sodium bicarbonate, magnesium chloride, and water.

A crystallizer apparatus, comprising a 500 mL jacketed glass beaker and an overhead mixer fitted with a pitched-blade impeller), was assembled. To the beaker, 258.5 g of room-temperature water was added, followed by 25.0 g of potassium chloride (OMRI-listed, commercial fertilizer grade). The mixture was stirred until the potassium chloride was fully dissolved. Next, 84.5 g of sodium bicarbonate (OMRI-listed, commercial food grade) was added to the beaker and stirred for 10 minutes. The chiller was then turned on at a setpoint of 5° C. Then, 106.3 g of a 30% by weight magnesium chloride solution (OMRI-listed, commercial fertilizer grade) in water was added to the mixture in 5 mL aliquots over 15 minutes. After approximately 25 g of magnesium chloride solution had been added, foaming was visible on the surface of the mixture due to evolution of carbon dioxide gas. When foaming was observed, addition of magnesium chloride solution was paused until the foam subsided. Foaming and evolution of carbon dioxide continued for 60 minutes after magnesium chloride solution addition was completed. The mixture was then stirred at 5° C. and 300 rpm for 8 hours. The solids in the final slurry consisted of white, fast-settling crystals.

Next, the slurry was transferred to a 1-L stainless-steel filter apparatus fitted with a 15-cm diameter, 1-micron polypropylene filter cloth. The apparatus was sealed, and compressed air at up to 2 barg was applied to separate the liquid phase (filtrate) from the solids, which were retained on the filter cloth. The filter apparatus was then depressurized, opened, and 50 g of room-temperature water poured evenly over the cake to rinse the solids of residual soluble salts. The filter apparatus was resealed, and compressed air at up to 2 barg was applied to rinse and dewater the solids. The rinse solution was collected together with the filtrate.

The combined filtrate/wash sample was analyzed for sodium and potassium as previously described. The solids were analyzed by dissolving a 0.5 g sample in 15 mL of 5% acetic acid solution, then diluting to 50 mL with water. The potassium and sodium concentrations in the dissolved sample were analyzed by ion-selective electrode. The solids were found to contain 26.2% potassium as potassium bicarbonate. The conversion of potassium to Engel's salt was determined to be 70%.

This example demonstrates that Engel's salt can be synthesized in the absence of nesquehonite by reaction of potassium chloride, sodium bicarbonate, and magnesium chloride in water 5° C. The observed conversion of 70% confirms that an initial charge of nesquehonite is not required for Engel's salt crystallization.

### Example 6

An experiment was conducted to determine the feasibility of recycling Engel's salt from batch-to-batch.

Cycle 1: A crystallizer apparatus, comprising a 500 mL jacketed glass beaker and an overhead mixer fitted with a pitched-blade impeller, was assembled. To the beaker, 233.3 g of room-temperature water was added, followed by 75.0 g of potassium chloride (OMRI-listed, commercial fertilizer grade). The mixture was stirred for 5 minutes until the potassium chloride was dispersed, forming a concentrated solution/slurry. Next, 77.91 g of sodium bicarbonate (OMRI-listed, commercial food grade) was added to the beaker and stirred for 5 minutes. Over 30 minutes, 228.3 g of nesquehonite (assay 64%/balance water, obtained by crystallization methods known in the art) was added. The recirculating chiller was set to 3° C., and the mixture was stirred for 4 hours.

Next, the slurry was transferred to a 1-L stainless-steel filter apparatus fitted with a 15-cm diameter, 1-micron polypropylene filter cloth. The apparatus was sealed, and compressed air at up to 2 barg was applied to separate the liquid phase (filtrate) from the solids, which were retained on the filter cloth. The filter apparatus was then depressurized, opened, and 50 g of room-temperature water poured evenly over the cake to rinse the solids of residual soluble salts. The filter apparatus was resealed, and compressed air at up to 2 barg was applied to rinse and dewater the solids. The rinse solution was collected with the filtrate.

The combined filtrate/wash sample was analyzed for sodium, potassium, and bicarbonate using methods described in previous examples. The conversion of potassium to Engel's salt was determined to be 88%.

Next, a potassium bicarbonate solution was obtained by leaching the solids with water using methods known in the art. The resulting slurry was then filtered on a 1-L stainless-steel filter apparatus fitted with a 15-cm diameter, 1-micron polypropylene filter cloth, to yield a filtrate containing 6.3% potassium as potassium bicarbonate. The solids in the filter were then washed with water to rinse the solids of soluble potassium bicarbonate. A total of 73.4 g of potassium bicarbonate was recovered between the filtrate and wash streams from filtration. The remaining solids were found to contain 0.3% potassium as potassium bicarbonate and a nesquehonite assay of 58.6% (balance water), with 223.4 g of 58.4% nesquehonite recovered.

Cycle 2: Next, the recovered nesquehonite from Cycle 1 was used to prepare Engel's salt in a subsequent crystallization. The crystallizer apparatus previously described was reassembled. To the beaker, 233.3 g of room-temperature water was added, followed by 75.0 g of potassium chloride (OMRI-listed, commercial fertilizer grade). The mixture was stirred for 5 minutes until the potassium chloride was dispersed, forming a concentrated solution/slurry. Next, 77.91 g of sodium bicarbonate (OMRI-listed, commercial food grade) was added to the beaker and stirred for 5 minutes. Over 30 minutes, 210.73 g of the recovered nesquehonite was added. Then, 21.0 g of new nesquehonite (assay 64%/balance water) was added. The recirculating chiller was set to 5° C., and the mixture was stirred for 4 hours.

Next, the slurry was transferred to a 1-L stainless-steel filter apparatus fitted with a 15-cm diameter, 1-micron polypropylene filter cloth. The apparatus was sealed, and compressed air at up to 2 barg was applied to separate the liquid phase (filtrate) from the solids, which were retained on the filter cloth. The filter apparatus was then depressurized, opened, and 50 g of room-temperature water poured evenly over the cake to rinse the solids of residual soluble salts. The filter apparatus was resealed, and compressed air at up to 2 barg was applied to rinse and dewater the solids. The rinse solution was collected with the filtrate.

The combined filtrate/wash sample was analyzed for sodium, potassium, and bicarbonate using methods described in previous examples. The conversion of potassium to Engel's salt was determined to be 87%.

Next, a potassium bicarbonate solution was obtained by leaching the solids with water using methods known in the art and utilizing the wash water from Engel's salt leaching collected from Cycle 1 to offset a portion of the water utilized for leaching. The resulting slurry was then filtered on a 1-L stainless-steel filter apparatus fitted with a 15-cm diameter, 1-micron polypropylene filter cloth, to yield a filtrate containing 6.8% potassium as potassium bicarbonate. The solids in the filter were then washed with water to rinse the solids of soluble potassium bicarbonate. The remaining solids were found to contain 0.2% potassium as potassium bicarbonate and a nesquehonite assay of 57.5% (balance water), with 219.9 g of 57.5% nesquehonite recovered.

Cycle 3: Next, the recovered nesquehonite from Cycle 2 was used to prepare Engel's salt in a subsequent crystallization. The crystallizer apparatus previously described was reassembled. To the beaker, 263.5 g of room-temperature water was added, followed by 75.0 g of potassium chloride (OMRI-listed, commercial fertilizer grade). The mixture was stirred for 5 minutes until the potassium chloride was dispersed, forming a concentrated solution/slurry. Next, 77.9 g of sodium bicarbonate (OMRI-listed, commercial food grade) was added to the beaker and stirred for 5 minutes. The recirculating chiller was then set to 5° C. and the mixture was allowed to cool to 10° C. before proceeding. Then, 42.5 g of 30% magnesium chloride solution in water (OMRI-listed, commercial fertilizer grade) was added over 5 minutes. Some foaming was observed during addition of magnesium chloride. Next, 14.2 g of sodium carbonate (commercial food grade) was added over 5 minutes. Finally, 219.9 g of 57.5% nesquehonite (balance water) from Cycle 2 was added to the mixture over 1 hour. The recirculating chiller remained set to 5° C., and the mixture was stirred for 4 hours.

Next, the slurry was transferred to a 1-L stainless-steel filter apparatus fitted with a 15-cm diameter, 1-micron polypropylene filter cloth. The apparatus was sealed, and compressed air at up to 2 barg was applied to separate the liquid phase (filtrate) from the solids, which were retained on the filter cloth. The filter apparatus was then depressurized, opened, and 50 g of room-temperature water poured evenly over the cake to rinse the solids of residual soluble salts. The filter apparatus was resealed, and compressed air at up to 2 barg was applied to rinse and dewater the solids. The rinse solution was collected with the filtrate.

The combined filtrate/wash sample was analyzed for sodium, potassium, and bicarbonate using methods described in previous examples. The conversion of potassium to Engel's salt was determined to be 86%.

Thus, this example proves that the nesquehonite produced by leaching of Engel's salt in water to yield potassium bicarbonate is active towards the subsequent preparation of additional Engel's salt in the methods described in this patent.

### Example 7

An experiment was conducted to scale-up the crystallization of Engel's salt and subsequent recovery of potassium bicarbonate by leaching.

A crystallizer apparatus, comprising a 5.5 L jacketed stainless steel reactor and an overhead mixer with a pitched-blade impeller, was assembled. To the reactor, 1,191 g of room-temperature tap water was added, followed by 529.9 g of potassium chloride (OMRI-listed, commercial fertilizer grade). The mixture was stirred for 5 minutes until the potassium chloride was dispersed, forming a concentrated solution/slurry. Next, 519.5 g of sodium bicarbonate (OMRI-listed, commercial food grade) was added to the beaker and stirring continued for 5 minutes. Then, 23 g of a 30% by weight magnesium chloride solution in water (OMRI-listed, commercial fertilizer grade) was added. Next, 1,297.6 g of nesquehonite with assay of 70.2% (obtained by crystallization using methods known in the art, or alternatively, obtainable from natural materials or by leaching of Engel's salt) was added over 20 minutes. The recirculating chiller was set to 5° C. and stirring continued for 8 hours.

Next, the slurry was transferred into a stainless-steel filter apparatus fitted with a 15-cm diameter, 1-micron polypropylene filter cloth. The filter was then sealed and compressed air at up to 2 barg was applied to separate the liquid phase (filtrate) from the solids, which were retained on the filter cloth. The filter apparatus was then depressurized, opened, and 960 g of room-temperature water poured evenly over the cake to rinse the solids of residual soluble salts. The filter apparatus was resealed, and compressed air at up to 2 barg was applied to rinse and dewater the solids. The rinse solution was collected in a separate container from the filtrate. Air flow continued until no additional liquid droplets were observed leaving the filter. The mass of solids, filtrate, and rinse were recorded.

The filtrate, wash, and solids samples were analyzed for sodium, potassium, and bicarbonate as previously described. From this filtration, 1,839.2 g of solids containing 27.3% potassium as potassium bicarbonate were recovered. The conversion of potassium to Engel's salt was determined to be 86%. The recovered solids were largely free of sodium, containing only 0.6% sodium as sodium bicarbonate, giving a potassium/sodium mass ratio of 60.0.

### Example 8

This example describes a proposed, full-scale batch process for producing potassium bicarbonate based on the methods described herein. The process is designed for producing 200-250 metric tons per year potassium bicarbonate product, operating on a 24-hr cycle with 3-5 batches processed sequentially per day.

A jacketed vessel for precipitation of Engel's salt is charged with 600-1200 L of room-temperature water. Then, 180-240 kg of potassium chloride (commercial fertilizer grade) is added, and the contents of the vessel are stirred using an agitator. Next, 180-240 kg of sodium bicarbonate (commercial food grade) is added to the vessel and the mixture stirred for 10 minutes until the solids are well-dispersed. Next, 60-120 kg of 30% magnesium chloride solution (commercial fertilizer grade) is added to the vessel over 5 minutes. Then, 20-40 kg of sodium sesquicarbonate (commercial feed grade) is added to the vessel over 5 minutes. Finally, 350-500 kg of nesquehonite (dry-basis, recycled or sourced using methods known in the art) are added to the vessel over 30 minutes. The contents of the vessel are cooled to 5° C. using a chiller and the mixture stirred for 3-6 hours to precipitate potassium as Engel's salt.

The resulting Engel's salt slurry is then transferred to a plate-and-frame filter press for separation of the solids and liquid. The solids are retained in the filter press chambers while the liquid filtrate is separated and directed to a separate vessel for further processing of the sodium chloride solution. The solids in the filter are then dewatered, washed with 150-300 L of cold water, and dewatered again. The wash water can be directed back to the jacketed vessel for precipitation of Engel's salt and reduce the quantity of water charged to the subsequent batch, or it can be collected with the filtrate solution and sent on for further processing of the sodium chloride brine.

The filtrate containing sodium chloride brine solution is then held in a storage tank which also serves as a clarifier for any solids which pass through the filter, or are formed during storage. The clarified sodium chloride brine is decanted from this vessel and sent on to further processing and the solids settle to the bottom of the vessel. The resulting solids slurry is occasionally pumped back to the vessel for precipitation of Engel's salt for recycle.

Next, the solids containing Engel's salt are discharged from the filter press. Separately, another jacketed vessel for leaching of Engel's salt is charged with 1,300-4,000 L of 40-60° C. water and recycled wash solution from previous Engel's salt leaching filtration and washing batches. The solids containing Engel's salt from the previous crystallization step are then charged into the vessel, and the contents of the vessel are stirred using an agitator while the heating jacket warms the contents of the vessel to between 60-70° C. The slurry is held at 60-70° C. for 20-30 minutes and then transferred using a pump to a plate-and-frame filter press for separation of the solids and liquid. The solids, comprising primarily nesquehonite, are retained in the filter press chambers while the liquid filtrate, containing primarily potassium bicarbonate, is separated and directed to a separate vessel for further processing. The solids in the filter are then dewatered, washed with 200-1000 L of 15-55° C. water, and again dewatered. The collected wash water can then be directed back to the jacketed vessel for leaching of Engel's salt and reduce the quantity of water charged to the subsequent batch, or it can be collected with the potassium bicarbonate filtrate and sent on for further processing. A portion of the solids are discarded as required to reduce the accumulation of insoluble impurities, and the remaining solids are recycled to the vessel for crystallization of Engel's salt for subsequent batches.

The potassium bicarbonate solution from filtration is collected in a jacketed vessel where the contents are cooled to 10-30° C. The vessel also serves as a clarifier for any solids that pass through the filter or are formed during cooling. The filtrate is pumped on for further processing to potassium bicarbonate, and the solids slurry formed is collected at the bottom of the vessel is occasionally pumped back to the vessel for leaching of Engel's salt for reprocessing. Alternatively, the hot potassium bicarbonate filtrate, and the wash stream if so directed with the filtrate, may be further processed directly without cooling and separation of the solids formed on cooling.

The potassium bicarbonate solution is then directed to a spray dryer to be recovered as a solid product using methods known in the art. The resulting potassium bicarbonate solids may then be packaged and sold, blended with other materials to form a specific end use product, or processed into potassium carbonate using thermal calcination methods known in the art. Alternatively, the potassium bicarbonate solution from Engel's salt leaching may be directly evaporated to form a concentrated solution with loss of carbon dioxide on heating using methods known in the art, thus forming a concentrated potassium carbonate solution.

### Example 9

This example describes a proposed, full-scale continuous process for producing potassium bicarbonate based on the methods described herein. The process is designed for producing 4,500 metric tons per year potassium bicarbonate product operating at 85% on-stream time.

A crystallizer vessel for precipitation of Engel's salt is continuously fed with 1,180-2,400 kg/hr of water. Simultaneously, 500-675 kg/hr of potassium chloride (commercial fertilizer grade), 500-675 kg/hr sodium bicarbonate (commercial food grade), 180-365 kg/hr 30% magnesium chloride solution (commercial fertilizer grade), 60-120 kg/hr sodium sesquicarbonate (commercial feed grade), and 920-1,320 kg/hr of nesquehonite (dry-basis, recycled or sourced using methods known in the art) are added continuously using suitable feeding mechanisms known in the art. The contents of the crystallizer vessel are maintained around 0-5° C. using a heat exchanger and circulating chiller system. The crystallizer vessel is appropriately sized to provide 3-6 hours of residence time for the crystallization of Engel's salt. The crystallizer vessel design may be a continuous stirred-tank reactor, forced-circulation crystallizer, draft tube baffle crystallizer, or other suitable crystallizer designs known in the art.

The slurry from the crystallizer containing Engel's salt is then transferred to a continuous solid/liquid separation step for recovery of Engel's salt and sodium chloride-containing brine solution. A filtrate stream containing sodium chloride brine is recovered from the initial filtration zone. Next, the solids are washed with 390-790 L/hr cold water to remove residual sodium chloride and then dewatered to yield a solid stream containing Engel's salt. The wash water can be directed back to Engel's salt crystallization step to offset the rate of fresh water charged, or it can be collected with the filtrate solution and sent on for further processing of the sodium chloride brine. The solid/liquid separation technology may be any suitable continuous separation, filtration, or centrifugation method known in the art which allows for recovery of filtrate, washing of solids, and dewatering of solids.

The filtrate containing sodium chloride brine solution is then transferred clarifier vessel for separation of any solids which pass through the filter or are formed during storage. The clarified sodium chloride brine overflows from this vessel and is sent on to further processing of the sodium chloride solution. The solids settle to the bottom of the vessel to form a slurry which is continuously pumped back to the Engel's salt crystallizer for recycle.

The recovered solids containing Engel's salt are then continuously introduced into a vessel for leaching of Engel's salt to produce a potassium bicarbonate solution and nesquehonite for recycle. The solids containing Engel's salt are continuously added to this vessel and 3,400-10,500 L/hr of 40-60° C. water is charged simultaneously. The contents of the vessel are warmed to between 60-70° C. and the crystallization vessel is appropriately sized to provide 20-30 minutes residence for the leaching of Engel's salt to form potassium bicarbonate and nesquehonite. The vessel design may be a continuous stirred-tank reactor, forced-circulation crystallizer, draft tube baffle crystallizer, or other suitable crystallizer or stirred tank reactor designs known in the art.

The slurry from the Engel's salt leaching process is then transferred to a continuous solid/liquid separation step for recovery of nesquehonite and potassium bicarbonate solution. A filtrate stream containing potassium bicarbonate is recovered from the initial filtration zone. Next, the solids are washed with 500-2,600 L/hr cold water to remove residual potassium bicarbonate and then dewatered to yield a solid stream containing nesquehonite. The wash water stream can be continuously directed back to Engel's salt leaching step to offset the rate of water charged, or it can be collected with the filtrate solution and sent on for further processing of the potassium bicarbonate solution. The solid/liquid separation technology may be any suitable continuous separation, filtration, or centrifugation method known in the art which allows for recovery of filtrate, washing of solids, and dewatering of solids.

The potassium bicarbonate solution from filtration is then continuously cooled to 10-30° C. using a heat exchanger and then transferred to a clarifier to remove any solids that pass through the filter or are formed during cooling. The clarified filtrate containing potassium bicarbonate is transferred on for further processing to potassium bicarbonate, and the solids slurry formed is collected at the bottom of the clarifier and is continuously pumped back to the Engel's salt leaching process for reprocessing. Alternatively, the hot potassium bicarbonate filtrate, and the wash stream if so directed with the filtrate, may be further processed directly without cooling and separation of the solids formed on cooling.

The potassium bicarbonate solution is then directed to a spray dryer to be recovered as a solid product using methods known in the art. The resulting potassium bicarbonate solids may then be packaged and sold, blended with other materials to form a specific end use product, or processed into potassium carbonate using thermal calcination methods known in the art. Alternatively, the potassium bicarbonate solution from Engel's salt leaching may be directly evaporated to form a concentrated solution with loss of carbon dioxide on heating using methods known in the art, thus forming a concentrated potassium carbonate solution.

### Other Embodiments

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

### REFERENCES CITED

All publications, patents, patent applications and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present invention.

What is claimed is:

1. A method for extracting potassium bicarbonate from a mineral mixture, comprising:
combining potassium chloride, sodium bicarbonate, and magnesium carbonate trihydrate in an aqueous solution;
cooling the aqueous solution to form Engel's salt comprising potassium bicarbonate magnesium carbonate tetrahydrate;
separating Engel's salt from the aqueous solution; and
leaching Engel's salt with water to produce an aqueous potassium bicarbonate solution and magnesium carbonate trihydrate.

2. The method of claim 1, wherein cooling the aqueous solution comprises cooling to a temperature between 0° C. and 20° C.

3. The method of claim 1, further comprising adding magnesium chloride to the aqueous solution.

4. The method of claim 1, wherein leaching Engel's salt comprises heating to a temperature between 40° C. and 70° C.

5. The method of claim 1, further comprising recycling at least a portion of the magnesium carbonate trihydrate produced from leaching Engel's salt back into the aqueous solution.

6. The method of claim 5, further comprising purging 0-20% of the recycled magnesium carbonate trihydrate.

7. The method of claim 1, further comprising processing the aqueous potassium bicarbonate solution to produce a potassium bicarbonate product selected from the group consisting of: an aqueous solution, a crystallized solid, and a spray-dried powder.

8. A system for extracting potassium bicarbonate from a mineral mixture, comprising:
a crystallization unit configured to combine potassium chloride, sodium bicarbonate, and magnesium carbonate trihydrate in an aqueous solution and cool the aqueous solution to form Engel's salt comprising potassium bicarbonate magnesium carbonate tetrahydrate;
a separation unit configured to separate Engel's salt from the aqueous solution; and
a leaching unit configured to leach Engel's salt with water to produce an aqueous potassium bicarbonate solution and magnesium carbonate trihydrate.

9. The system of claim 8, wherein the crystallization unit is configured to cool the aqueous solution to a temperature between 0° C. and 20° C.

10. The system of claim 8, further comprising a magnesium chloride addition unit configured to add magnesium chloride to the aqueous solution in the crystallization unit.

11. The system of claim 8, wherein the leaching unit is configured to heat Engel's salt and water to a temperature between 40° C. and 70° C.

12. The system of claim 8, further comprising a recycling unit configured to recycle at least a portion of the magnesium carbonate trihydrate produced from leaching Engel's salt back into the crystallization unit.

13. The system of claim 12, further comprising a purge unit configured to purge 0-20% of the recycled magnesium carbonate trihydrate.

14. The system of claim 8, further comprising a processing unit configured to process the aqueous potassium bicarbonate solution to produce a potassium bicarbonate product.

15. The system of claim 14, wherein the processing unit is configured to produce a potassium bicarbonate product selected from the group consisting of: an aqueous solution, a crystallized solid, and a spray-dried powder.

16. A method for producing potassium bicarbonate, comprising:
forming Engel's salt comprising potassium bicarbonate magnesium carbonate tetrahydrate from a mixture of potassium chloride, sodium bicarbonate, and magnesium carbonate trihydrate;
separating Engel's salt from the mixture; and
decomposing Engel's salt to yield an aqueous potassium bicarbonate solution.

17. The method of claim 16, wherein forming Engel's salt comprises cooling an aqueous solution containing the potassium chloride, sodium bicarbonate, and magnesium carbonate trihydrate to a temperature between 0° C. and 20° C.

18. The method of claim 17, further comprising adding magnesium chloride to the aqueous solution prior to cooling.

19. The method of claim 16, wherein decomposing Engel's salt comprises heating Engel's salt with water to a temperature between 40° C. and 70° C.

20. The method of claim 19, further comprising recycling at least a portion of magnesium carbonate trihydrate produced from decomposing Engel's salt back into the mixture for forming additional Engel's salt.
